(19) United States
(12) Patent Application Publication
(10) Pub. No.: US 2011/0105133 A1
(43) Pub. Date: May 5, 2011

(54) RESTRICTED ACCESS IN CELLULAR COMMUNICATION SYSTEMS

(75) Inventors: Gerard T. Foster, Marston Meysey (GB); Stephen J. Barrett, Curridge (GB); Luis Lopes, Swindon (GB)

(73) Assignee: MOTOROLA, INC., Schaumburg, IL (US)

(21) Appl. No.: 12/613,108

(22) Filed: Nov. 5, 2009

(51) Int. Cl. H04W 72/04

(52) U.S. Cl. 455/450

(57) ABSTRACT

A cellular communication system comprises a base station which can to operate in a restricted mode wherein support is restricted to user equipments of a first associated set of user equipments, such as a Closed Subscriber Group. The base station comprises a profile unit which determines a first transmit power profile where the first transmit power profile is indicative of the base station operating in the restricted mode. The base station further comprises a transmitter for transmitting at least one common channel, such as a pilot signal or a broadcast signal, with a transmit power according to the first transmit power profile. User Equipments may measure the power profile to evaluate whether the base station employs restricted access. The invention may in particular reduce the number of access attempts to restricted base stations by non-eligible User Equipments.

### FIELD OF THE INVENTION

The invention relates to a cellular communication system employing base stations with restricted access and in particular, but not exclusively, to restricted access base stations in a Universal Mobile Telecommunications System (UMTS).

### BACKGROUND OF THE INVENTION

A method which has been used to increase the capacity of cellular communication systems is the concept of hierarchical cells wherein a macro-cell layer is underlayed by a layer of typically smaller cells having coverage areas within the coverage area of the macro-cell. In this way, smaller cells, known as micro-cells, pico-cells, or femto-cells, are located within the same coverage area as larger macro cells. The pico-cells and femto-cells have much smaller coverage thereby allowing a much closer reuse of resources. Frequently, the macro-cells are used to provide coverage over a large area, and the smaller underlay cells are used to provide additional capacity in e.g. densely populated areas and hotspots. Furthermore, femto-cells can also be used to provide coverage in specific locations such as within a residential home or office.

The current trend is towards introducing a large number of femto-cells to 3G systems. For example, it is envisaged that Residential Access Points (RAPs) or Home Node-Bs (HNBs) may be deployed to have a target coverage area of only a single residential dwelling or house. A widespread introduction of such systems would result in a very large number of small underlay cells within a single macro-cell. Furthermore, such RAPs and HNBs are often designed to support only a selected group of User Equipments (UEs) or subscribers. For example, a RAP or HNB may be installed in a home to support only members of that household but not any visitors or other subscribers in the vicinity of the RAP or HNB.

The usage of femto-cells (including RAPs and HNBs) restricted to support a specific subscriber set is becoming very popular and widespread. It has been acknowledged that for such cells, the unwanted signaling from UEs that are not able to be supported by the femto cell is problematic since it results in a significant increase in the loading of the femto-base station. For example, a UE detecting a strong pilot signal from a femto-base station may proceed to access this. However, following a signalling exchange, this access request will inevitably be rejected by the femto-base station if the UE does not belong to the set of permitted UEs.

Currently, the 3^{rd} Generation Partnership Project (3GPP) is in the process of standardizing a network architecture known as the Evolved Packet System (EPS). This work introduces a new concept called Closed Subscriber Groups (CSGs) which is used to restrict access to parts of the Evolved UTRAN (E-UTRAN (UMTS (Universal Mobile Telecommunications System) Terrestrial Radio Access Network)). EPS introduces a base station type known as a Home EUTRAN Node-B (HeNB) to (in particular) support the femto-layer (such as residential or office applications). The information broadcast from such an HeNB includes a single bit which can indicate that the Home HeNB is operating a CSG policy preventing any UE not belonging to the permitted group of UEs to be supported by the HeNB (or more specifically by a cell belonging to the HeNB). Accordingly, the UE may monitor this bit in order to determine whether it should access a detected HeNB cell (i.e. if it does not belong to the CSG of the HeNB cell, it should not attempt to access this). Consequently, the loading of the HeNB is reduced as there is no signalling from non-permitted UEs. In addition, the resource requirement is reduced for the UE leading to increased battery life.

However, although this system works well in many scenarios, it also has some disadvantages. For example, in order to determine whether it can access a given base station, the UE needs to fully decode the broadcast channel in order to determine the value of the bit indicating whether the base station is restricted. This requires complex signal processing and will tend to reduce battery life.

Furthermore, many other systems do not include any provision or option for including such data in the broadcast data from a base station.

Hence, an improved approach would be advantageous and in particular an approach allowing increased flexibility, reduced resource requirements, improved suitability for various communication systems, facilitated operation and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a cellular communication system comprising: a base station arranged to operate in a restricted mode wherein support is restricted to user equipments of a first associated set of user equipments; the base station further comprising: a profile unit for determining a first transmit power profile, the first transmit power profile being indicative of the base station operating in the restricted mode; and a transmitter for transmitting at least one common channel with a transmit power according to the first transmit power profile.

The invention may provide improved operation and/or performance and/or facilitated operation. The invention may provide improved support for base stations supporting only a limited set of UEs. In particular, the invention may provide improved support for closed subscriber group operation. The approach may specifically reduce signalling in a cellular communication system and may in many embodiments reduce the loading of the base station. Also, in many scenarios, resource usage and/or complexity for user equipments may be reduced and in particular battery life may be extended.

According to another aspect of the invention there is provided a base station for a cellular communication system, the base station being arranged to operate in a restricted mode wherein support is restricted to user equipments of a first associated set of user equipments; the base station comprising: a profile unit for determining a first transmit power profile, the first transmit power profile being indicative of the base station operating in the restricted mode; and a transmitter for transmitting at least one common channel with a transmit power according to the first transmit power profile.

According to another aspect of the invention there is provided a method of operation for a cellular communication system comprising a base station arranged to operate in a restricted mode wherein support is restricted to user equipments of a first associated set of user equipments; the method comprising: determining a first transmit power profile, the first transmit power profile being indicative of the base station operating in the restricted mode; and transmitting at least one common channel from the base station with a transmit power according to the first transmit power profile.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of elements of a cellular communication system in accordance with some embodiments of the invention;

FIG. 2 is an illustration of elements of a base station in accordance with some embodiments of the invention;

FIG. 3 is an illustration of elements of a user equipment of a cellular communication system in accordance with some embodiments of the invention; and

FIG. 4 is an illustration of transmit power profiles for base stations of a cellular communication system in accordance with some embodiments of the invention.

### DETAILED DESCRIPTION OF SOME EMBODIMENTS OF THE INVENTION

The following description focuses on embodiments of the invention applicable to a UMTS cellular communication system. However, it will be appreciated that the invention is not limited to this application but may be applied to many other cellular communication systems.

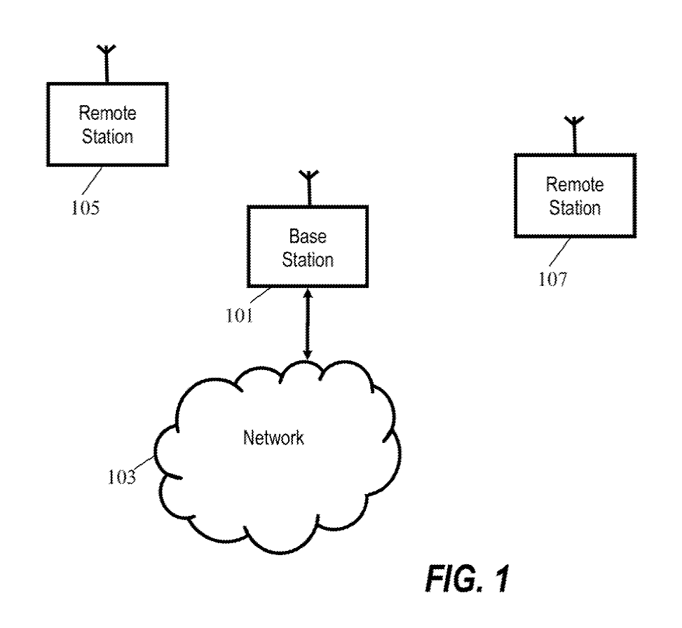

FIG. 1 illustrates an example of some elements of a cellular communication system in accordance with some embodiments of the invention. FIG. 1 illustrates a base station 101 which specifically is a Residential Access Point (RAP) or Home Node B (HNB). The base station 101 is in the specific example a base station supporting a femto-cell corresponding to a single dwelling. Furthermore, the base station 101 is intended to support only members of the household of the dwelling whereas other UEs/subscribers in the area covered by the femtocell are intended to be supported by an overlaying micro or macro-cell. Accordingly, the base station 101 operates a restricted access policy that allows access only to UEs that belong to a set of permitted UEs. The set of permitted UEs may specifically be defined by data received from an operator or may e.g. be generated or managed partly or fully by local management functionality. For example, the base station 101 may be arranged to allow a maximum of ten UE identities to be included in the permitted set and the user may directly and manually specify the UE identities to be included.

It will be appreciated that the term access may include any operation that involves the base station providing any support for a UE whether passive or active. For example, a UE accessing a base station may include an idle mode cell reselection, a paging response, an active mode access (either for an ongoing communication or when setting up a new communication).

The base station is coupled to a network 103 which represents the remaining parts of the fixed segment of the cellular communication system. Thus, as will be well known to the person skilled in the art the network may include other Node Bs (base stations); Radio Network Controllers (RNCs), a core network, other Radio Access Networks (RANs) etc.

FIG. 1 furthermore illustrates two UEs 105, 107 representing UEs currently within or approaching the femto-cell.

In the system of FIG. 1, UEs are only supported by the base station 101 if they belong to the permitted set of UEs. Thus, the base station 101 will only be a serving base station for UEs that belong to the permitted set of UEs defined for the base station 101. Specifically, any access or service requests (whether in idle mode or in active mode) from UEs that are not included in the permitted set are unconditionally rejected by the base station 101.

In the system of FIG. 1, the base station 101 broadcasts one or more channels. Specifically, a pilot signal is transmitted that allows the UEs 105, 107 to detect the presence of the base station 101 to evaluate whether a handover or cell reselection to the base station 101 may be advantageous. In the specific example, the base station 101 broadcasts a number of broadcast channels in accordance with the UMTS specifications, including logical channels such as the BCCH (Broadcast Control CHannel) and the PCCH (Paging Control CHannel), transport channels such as the BCH (Broadcast CHannel) and the PCCH (Paging Control CHannel), and physical channels such as the PCCPCH (Primary Common Control Physical CHannel, the (SCH) Synchronisation CHannel and the CPICH (Common PIlot CHannel) etc.

In the system, the transmit power profile for one or more of these channels is used to indicate that the base station 101 operates in a restricted mode where only a selected set of UEs are supported. The restricted mode may be a permanent mode i.e. the base station 101 may always operate with a restricted access policy.

In the system, the transmit power of one or more of the common channels is varied in accordance with a transmit power profile that is indicative of the base station 101 operating in a restricted mode. In the system, UEs detecting the broadcast signal from the base station 101 can measure the transmit power variation for the common channel and determine whether to access the base station 101 or not depending on the measured profile. Hence, UEs that do not belong to any permitted group for a RAP or HNB, can avoid accessing any such restricted RAPs or HNBs. This may substantially reduce the signalling between UEs and RAPs/HNBs, and can accordingly substantially reduce the resource usage for both the UE and the RAPs/HNBs. The approach may further reduce the amount of transmissions associated with such signalling thereby resulting in a reduced interference to other UEs and accordingly an increased capacity of the system as a whole. Furthermore, the UEs may easily detect that the base station is a restricted access base station and specifically can base this detection on simple power measurements without requiring any transmissions or broadcast channels from the base station 101 to be fully decoded. This may reduce complexity and resource usage for the UEs and may e.g. increase battery life.

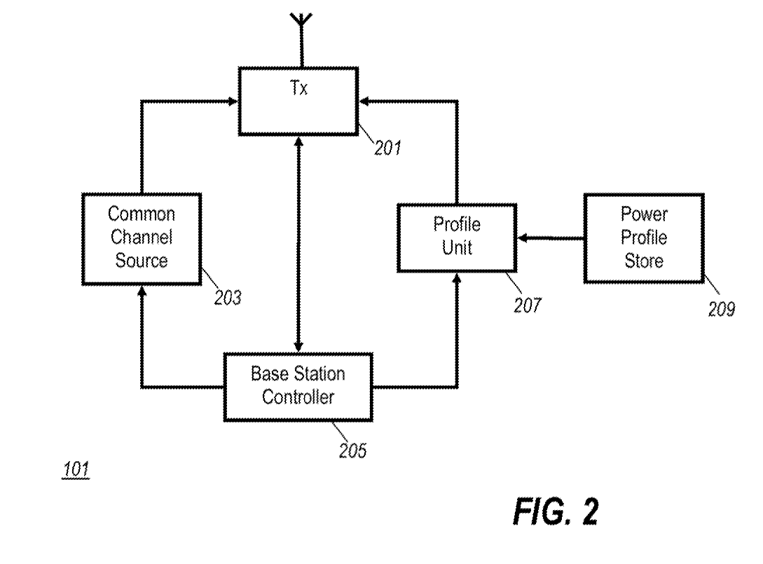

FIG. 2 illustrates the base station 101 in more detail. The base station 101 comprises a transceiver 201 which is arranged to transmit and receive air interface signals in accordance with the UMTS specifications. Specifically, the transceiver 201 can transmit or broadcast the common channels.

The base station 101 furthermore comprises a common channel source 203 which provides the common channels to the transceiver for transmission/broadcast. A common channel may in particular be considered to be a channel which is intended for more than one UE. Thus, a common channel may be considered a channel which is not a dedicated channel for a UE. In many scenarios, a common channel may be a channel which is common for all UEs supported by or potentially seeking to be supported by the base station 101. Thus, a common channel may be a channel that is intended for non-specific UE use. In the example, the common channel is a broadcast channel. it will be appreciated that the transmit power variations may be applied to a logical, transport and/or physical channel.

The common channel source 203 is coupled to a base station controller 205 which provides the data to be included in the common channels. The base station controller 205 is further arranged to control various aspects of the general operation of the base station 101 as will be known to the skilled person. For example, the base station controller 205 is arranged to couple the base station 101 to the network 103 and to receive and transmit user and control data to other network elements. The base station controller 205 is further arranged to generate the data of the common channels from data received from external sources (such as network elements of the network 103) and/or from a local evaluation of the operation of the base station.

Also, the base station controller 205 is arranged to control the access policy of the base station 101. The base station controller 205 maintains a list of identities for all UEs that are allowed to be supported or served by the base station 101. Accordingly, whenever an access request is received from a UE 105, 107, the base station controller 205 evaluates whether the UE identity (or alternatively or additionally the subscriber identity) matches a UE identity (and/or subscriber identity) which is stored in the set of permitted UE identities. If so, the base station controller 205 proceeds to process the access request in line with the normal procedures and standards for processing an access request. However, if the UE identity of the access request does not match any UE identities of the set of permitted UEs, the base station controller 205 proceeds to reject the access request. Thus, the base station 101 operates a restricted access policy and specifically only supports UEs belonging to a specific Closed Subscriber Group (CSG).

The base station controller 205 is further coupled to a profile unit 207 which is arranged to determine a transmit power profile to be used for transmission of at least one of the common channels. The transmit power profile is indicative of the fact that the base station 101 operates in a restricted access mode. In the example, the profile unit 207 is coupled to a power profile store 209 which stores one or more transmit power profiles. For example, a number of power profiles may be predetermined to correspond to different groups or classes of restricted access base stations, and the power profile store 209 may store a template for each of these profiles.

The base station controller 205 provides a control signal to the profile unit 207 indicating that the base station 101 is operating in a (potentially permanent) restricted access mode. This indication may further indicate which group or class the base station 101 belongs to for the restricted access mode. The profile unit 207 proceeds to access the power profile store 209 to retrieve the appropriate transmit power profile.

The profile unit 207 is further coupled to the transceiver 201 and is arranged to control the transmit power for at least one of the common channels in response to the determined transmit power profile. Thus, the profile unit 207 controls the transmit power such that the common channel(S) is(are) transmitted with a transmit power that follows the determined transmit power profile.

It will be appreciated that in some embodiments all common channels may be transmitted with the determined power profile, whereas in other embodiments only a subset of one or more of the common channels may be transmitted with the determined power profile with other common channels being transmitted with a fixed power, a dynamically varied (power controlled) transmit power or with another power profile. For brevity, the following description will focus on an embodiment where all common channels are transmitted with the determined power profile.

The UEs 105, 107 are arranged to measure the transmit power profiles of the common channels of the base stations they consider accessing. If the power profile indicates that the base station operates a restricted policy, the UEs only proceed to access the base stations if they belong to a restricted set.

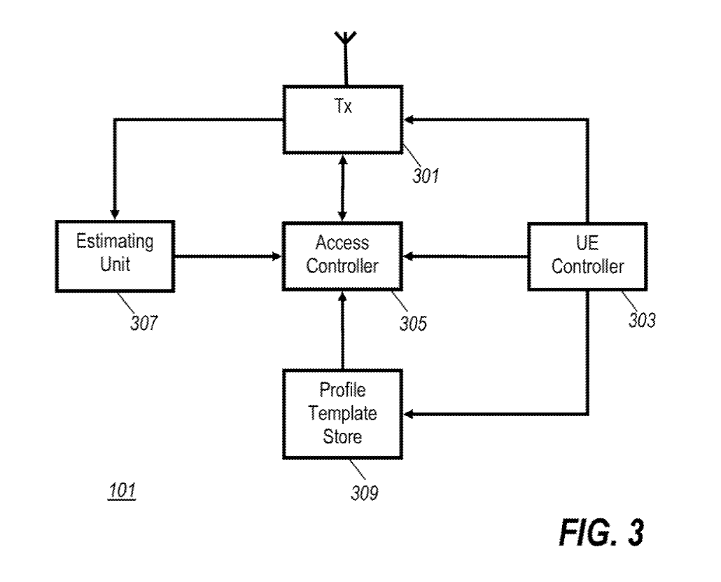

FIG. 3 illustrates examples of each of the UEs 105, 107 in more detail. The UEs 105, 107 comprise a transceiver 301 which is capable of communicating with base stations over the air interface of the communication system. The UEs 105, 107 further comprise a UE controller 303 which is arranged to control various aspects of the general operation of the UE 105, 107 as will be known to the skilled person. Specifically, the UE controller 303 is arranged to provide various control functions and operations required for the UEs 105, 107 to operate in accordance with the UMTS specifications. Also, the UE controller 303 is arranged to provide a user interface allowing user inputs to be received and user output to be generated.

The UEs 105, 107 also comprise an access controller 305 which is arranged to control the accessing of base stations by the UEs 105, 107. The access controller 305 is coupled to the UE controller 303 and the transceiver 301 and may be arranged to monitor for available base stations and to request access to a base station identified as a suitable base station. Such an access request may specifically be a new access request for an idle mode UE seeking to initiate a communication service or may e.g. be a handover request intended to handover an active mode UE from one base station to another.

In the system such access decisions are not only based on the availability of suitable base stations (e.g. received with a sufficiently high power level and/or quality) but is also subject to an evaluation of whether the base station operates a restricted access policy. Furthermore, this is determined on the basis of an evaluation of the transmit power profile of one or more of the common channels transmitted by the base station.

The UEs 105, 107 comprise an estimating unit 307 which is coupled to the transceiver 301 and the access controller 305. The estimating unit 307 is arranged to determine a transmit power profile estimate for at least one common channel received by the transceiver 301.

Specifically, the UE 105 may detect a high receive level and quality for a pilot signal transmitted by the base station 101. As a result it may consider the base station 101 to be a suitable/desirable serving base station. For example, if the UE is in idle mode, it may determine that it would be desirable to reselect to the base station 101 in order to camp on it (e.g. to monitor its paging messages). Alternatively, the UE 105 may currently be served by another base station and the UE controller 305 may determine that it would be desirable to handover to the base station 101. As another example, the UE 105 may currently be in idle mode but seeking to setup a new communication session setup. In this scenario the measurement of the pilot signal may lead the UE controller 305 to consider the base station 101 to be a suitable candidate as a serving base station.

The UE controller 303 may accordingly instruct the access controller 305 to seek to access the base station 101. In turn, the access controller 305 requests an estimated/measured transmit power profile for a suitable common channel transmitted by the base station 101.

In the example, the estimating unit 307 continuously monitors the control channel to estimate a transmit power profile. Thus, when the access controller 305 requests the power profile this can be provided immediately.

Typically, the estimating unit 307 determines the transmit power profile as data reflecting the variation of the transmit power for the common channel as a function of time. Specifically, the estimating unit 307 measures the received signal level for the control channel as a function of time. Typically, the transmit power profile comprises a repeating pattern and the estimating unit 307 averages the received signal level over a suitable number of repetitions in order to provide an estimated power profile where the impact of propagation characteristics has been reduced. Alternatively or additionally, the measurement may include a time averaging (low pass filtering) of the received signal level. Such averaging or low pass filtering is typically designed to not substantially affect the time domain power profile (i.e. it has a sufficiently high cut-off frequency to ensure that any impact on the detected power profile estimate is acceptable).

The access controller 305 then proceeds to evaluate the estimated power profile before deciding whether to access the base station 101 or not. Specifically, the access controller 305 may decide to terminate the access process if the estimated power profile is indicative of the base station 101 restricting access to a set of UEs to which the UE 105 does not belong.

As a low complexity example, a simple binary approach may be used. E.g. it may be specified that base stations which do not operate a restricted access policy use a constant transmit power whereas base stations that do operate a restricted access policy use a given transmit power with varying power as a function of time. In this case, the access controller 305 may determine which profile the power profile estimate provided by the estimating unit 307 is closest to. If this is the restricted access policy power profile, then the access controller 305 will only proceed with the access request if the UE belongs to at least one permitted set for at least one base station. However, if the UE 105 does not belong to any permitted sets, no access of the base station 101 is attempted.

In such a simple example, a UE that belongs to the permitted set of one specific base station may also proceed to access other base stations as it does not know whether the current detected base station is indeed the base station for which it belongs to the permitted set. Accordingly, whereas the number of accesses to the individual base station may be reduced, there may still be a number of access attempts that will automatically fail (i.e for UEs belonging to one restricted access base station seeking to access another base station).

In some embodiments, this may be addressed by each restricted base station having a dedicated transmit power profile such that the access controller 305 can compare the power profile estimate directly to the one to which it belongs and proceed to access only if they match. However, such an approach requires a large number of different transmit power profiles which in most systems is impractical as it is difficult to generate enough profiles while maintaining easy and reliable detection.

In the example of FIGS. 1-3, the system defines a set of predefined transmit power profiles. Such a set may typically advantageously contain 3-20 profiles. The individual restricted base stations may then be allocated or itself select one of these profiles. The distribution of the transmit power profiles may e.g. be centrally controlled to provide a suitable geographical spread or may e.g. be completely random. For example, each base station may individually and autonomously select one profile from the set. In this system, UEs will only access restricted base stations transmitting with a power profile that matches a profile of a restricted base station to which the UE belongs. This may substantially reduce the number of unnecessary access attempts while maintaining low complexity and providing profiles that are easy to detect reliably. As a rough approximation, in comparison to the binary case, the number of unnecessary accesses may be reduced by a factor corresponding to the number of profiles in the predefined set.

Thus, in the example, the transmitted power profile for the control channel not only indicates that the base station is operating a restricted policy but is also indicative of the specific restricted set In other words, the transmit power profile does not only allow differentiation between base stations that operate a restricted access policy and base stations that do not, but also allows differentiation between restricted access base stations and specifically between different permitted sets.

In the example, the base station 101 stores a set of all the predefined transmit power profiles in the power profile store 209. When setting up a permitted set (a CSG), the profile unit 207 selects a specific power profile from the available profiles and starts transmitting the common channels using this. In a possible implementation, the profile unit 207 may select the power profile based on e.g. the four most significant bits of the CSG Identity or another suitable mapping. In the example, the base station 101 supports only one permitted set and statically uses the selected profile. However, it will be appreciated that in other embodiments the base station 101 may support a plurality of permitted sets/CSGs (e.g. having different QoS permissions) and/or may dynamically switch between different profiles.

Similarly, the UEs 105, 107 comprise a profile template store 309 which stores a local comparison copy of the transmit power profiles for the permitted set(s)/CSGs that the UE 105, 107 belongs to.

It will be appreciated that any suitable method for determining and storing the power profile template information may be used. As a simple example, a RAP or HNB may be sold/installed with a permission to support up to ten UEs. In order to register a specific UE with the base station, the user may couple the UE to the base station, e.g. via a cable or a short link wireless connection. The UE and base station may then execute a suitable registration process which includes the base station receiving information of the specific UE identity and the UE receiving information of the transmit power profile being used for the common channels. The base station can then keep track of the maximum of concurrent registered UEs and restrict this to ten.

It will be appreciated that a UE may be registered with a plurality of base stations and/or permitted sets and that accordingly the profile template store 309 may store a plurality of profile templates.

Accordingly, whenever the access controller 305 of the UE 105, 107 has detected a possible serving base station, it proceeds to obtain the transmit power profile estimate from the estimating unit 307. It then proceeds to compare the power profile estimate with the profile that corresponds to the base station operating an unrestricted policy (typically a constant transmit power). If this matches, the access controller 305 proceeds with the access request. Otherwise it compares the profile estimate to the templates stored in the profile template store 309 and if a match is found it proceeds to access the base station. If no match is found, the access controller 305 terminates the process and does not transmit an access request to the base station. It will be appreciated that any suitable match criterion may be used, such as e.g. a requirement that a correlation value between the template and estimate exceeds a threshold.

Thus, in the specific example, the transmit power profile from the base station 101 provides an indication of the permitted set. However, in the example, this indication is only a partial identification of the permitted set/CSG as it will be shared by a potentially large number of permitted sets. However, in some embodiments, the common channel further comprises data further identifying the permitted set. This identification may be a further partial identification but is in the example a full unique identification of the permitted set.

Thus, in some embodiments, each permitted set may be allocated a unique identity and this identity may be included in the data of one or more of the common channels. In such embodiments, the UE 105, 107 may accordingly proceed to determine whether a matching profile template exists. If so, it proceeds to decode the common channel to extract the permitted set identity data. This is then compared to the identities of the permitted sets to which the UE 105, 107 belongs (e.g. stored in the profile template store 309) and if a match is found, the access controller 305 proceeds with the access request. Otherwise it terminates the process. This may result in access requests for restricted base stations being limited to UEs that are permitted to be served by the base stations (as well as possibly legacy UEs which do not comprise the described functionality). Thus a substantial reduction in the access loading may be achieved.

As a specific example, for a UMTS system the identity of the CSG(s) operated by a base station may be included in Broadcast Channel RRC (Radio Resource Control) IE (Information Element) Extensions.

In the example, the transmit power profile comprises a repeating pattern with at least one transmit period having a nominal transmit power and at least one transmit period having a reduced transmit power relative to the nominal power. The nominal transmit power may be any constant transmit power and is typically set to correspond to the desired coverage area for the cell. Furthermore, the reduced transmit power is typically substantially lower than the nominal power. Indeed in many embodiments, the reduced transmit power is at least 20 dB lower than the nominal transmit power. This may allow a substantially reduced interference to other base stations and may in many embodiments facilitate operation and reduce complexity. In many embodiments, the repeated pattern may essentially correspond to an on/off modulation of the common channels. Thus, in the example, the base stations that employ a restricted access policy transmit for only part of the time.

Furthermore, in the example, a transmit power frame for the common channel is divided into a plurality of time intervals. Each of the time intervals corresponds to a group/subset of permitted sets. In the example, base stations employing a restricted access policy are then limited to transmit the common channels (at nominal power) in only one of the intervals (i.e. the pattern may correspond to a transmission at the nominal power level within the selected interval and a transmission with the reduced power level (including no transmission) in all other time intervals).

Thus, in the example, the number of defined transmit power profiles is equal to the number of time intervals. Each defined transmit power profile corresponds to a transmission in only the corresponding time interval. Each defined transmit power profile, and thus each interval, corresponds to a subset of the possible permitted sets in the system. In some systems, each base station employing a restricted policy may individually and autonomously select a time interval in which to transmit.

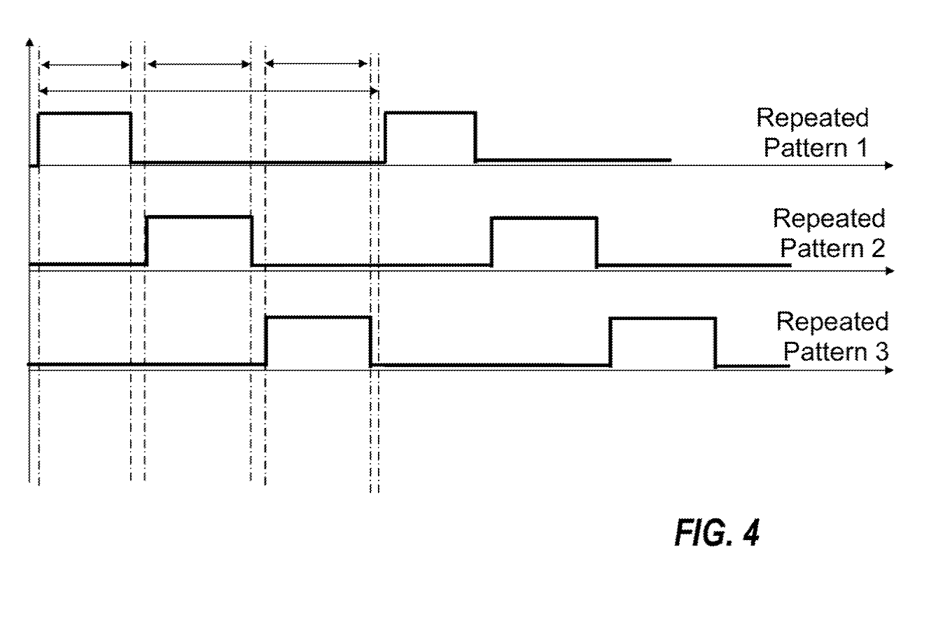

FIG. 4 illustrates an example wherein three time intervals are used, i.e. wherein three different transmit power profiles are defined in the system. Furthermore, in the example, the transmissions in each interval are substantially the same and correspond to a constant (nominal) transmit power. In the example, the differences between the different transmit power profiles (and the repeated patterns) is accordingly not the relative power variations but rather the timing of these. However, it will be appreciated that in other embodiments, the power variation patterns may differ and may be used to detect the specific transmit power profile.

In the example, the specific transmit power profile transmitted by the base station 101 is based on a timing synchronisation to a given frame (referred to as the transmit power frame). Therefore, the estimating unit 307 is arranged to determine the transmit power profile with reference to the transmit power frame for the common channels. This transmit power frame may correspond to the repetition frame for the intervals and is in the specific example related to a timing of the control channel itself.

Thus, in the example, the transmit power profiles are synchronised to a timing of the common channel itself. For example, the common channel may employ a data frame with the transmission intervals being defined relative to this data frame of the control channel. Accordingly, the estimating unit 307 may synchronise to the data frame and determine the timing of the window in which signals are detected for the common channel relative to this data frame.

The access controller 305 may accordingly proceed to evaluate whether to proceed in response to an evaluation of both a shape and a timing of the estimated transmit power profile. Specifically, the access controller 305 may first evaluate whether the shape of the transmit power estimate most closely resembles a constant power (corresponding to a non-restricted operation) or to a transmission in only around a third of the time (corresponding to a restricted mode). In the latter scenario, the access controller 305 may then proceed to determine whether the relative timing of the detected transmit window matches the timing of the transmit power profile stored in the profile template store 309. If so, it proceeds with the access and otherwise it terminates the process.

It will be appreciated that in other embodiments, the transmissions may be synchronised with other timing reference frames and the synchronisation to the transmit power frame by the UEs 105, 107 (and/or the base stations in some embodiments) may be achieved in other ways. For example, the system may distribute a suitable timing reference signal to all parties, the transmission of the common channel may itself provide synchronisation information (e.g. by a short pulse being transmitted at the start of all transmit power frames), and/or the base stations and UEs may individually determine a sufficiently accurate absolute time base (e.g. using synchronisation to a GPS system)

An advantage of the described approach is that the generated interference from the restricted access base stations may be substantially reduced. Indeed, in the specific example the interference may be reduced by a factor of around three as each base station only transmits in around a third of the time.

In the example, each pattern comprises only a single transmission and the base station 101 transmits only in the selected or allocated time interval. The concentration of the transmission into a single continuous transmission (within the interval) increases the time available for the UE to detect, decode and react to the common channel transmission.

In the described system, the duration of each transmission is such that it is sufficient for the UEs to decode the common channel(s) and to transmit an access request to the base station. Thus, the duration is designed to be sufficiently long for the UEs 105, 107 to extract data from the common channel and to transmit an access request. Thus, the transmit duration is such that a UE can successfully lock to the common channels for long enough to specifically decode the BCH channel and then make an RRC Connection request.

For UMTS and similar systems, it has been found that particularly advantageous performance can be found for transmission durations from 2 to 30 seconds and transmit power frame durations from 5 seconds to one minute, and typically more preferably for transmission durations from 3 to 10 seconds and transmit power frame durations from 7 seconds to 30 seconds.

In some embodiments, the base station 101 is arranged to operate in the restricted access mode continuously. However, in other embodiments and scenarios, the base station is arranged to switch between a non-restricted mode and a restricted mode. In such embodiments, the transmit power profile is used only when in the restricted mode whereas continuous transmission is used for the un-restricted mode.

Also, in some embodiments, the base station 101 may be able to switch between different modes while in the restricted mode where the different modes use different transmit power profiles.

For example, when the base station 101 is not currently supporting any UEs, the base station 101 station may operate as previously described and may specifically use a transmit power profile wherein transmissions occur only in selected intervals.

However, during periods where the base station 101 is actively supporting a UE (e.g. it is the serving base station for an active UE), the base station 101 may instead use a second transmit power profile. This, second transmit power profile may specifically correspond to a continuous transmission at a fixed power level, such as e.g. the nominal power level.

This will ensure that any UE served by the base station 101 can rely on the continuous presence of the common channel(s) and thus can be treated as a conventional UMTS base station. In particular, the active UE will have access to a continuous BCCH that can be used to maintain good channel estimation required for a RAKE receiver, which may be useful to serve UEs that are not aware of the transmit power profile (such as legacy UEs).

Thus, in such embodiments, the base station 101 may switch from the first mode to the second mode when it detects that a UE is supported by it. As a specific example, whenever an access process for a UE completes successfully for a base station that was previously not supporting any UEs, the base station may switch from using a transmit power profile as described with reference to FIG. 4 to using another transmit power profile that allows for the common channels to be continuously transmitted and thus received by the served UE.

Similarly, when it is detected that no user equipment is supported by the base station, the base station can switch back to the first mode of operation wherein the transmit power profile of FIG. 4 is used. Specifically, when the last remaining served UE hands over, is dropped or terminates the communication session, the base station may proceed to switch back to the first mode of operation.

The transmit power profile used in the second mode may be a constant transmit power as previously mentioned. However, in other embodiments, the same varying pattern as used in the first mode may be applied but with a reduced dynamic range. For example, a transmit power profile may be applied which corresponds to the nominal transmit power during the allocated or selected restricted access time interval and a constant transmit power which is reduced relative to the nominal power but which is still significant may be used outside this time interval. For example, the transmit power outside the selected time interval may be, say, 6 dB lower than the nominal power.

Such an approach may allow the common channels to be continuously available to the served UEs while still allowing the pattern indicative of the restricted operation to be detected by other UEs. Accordingly, it may reduce the access loading of the base station.

In some embodiments, the transmit power during the second mode may be determined in response to a power control loop that includes the UE(s) currently served by the base station. Indeed, the served UEs may transmit power control feedback information for the common channels back to the base station. The base station may then increase or decrease the transmitted power level depending on this control data. In such embodiments, this may allow for the transmit power to be adjusted such that it is sufficient for the served UE to access the common channel while at the same time ensuring that it is as low as possible in order to reduce interference.

In some such embodiments, the power control is applied such that the pattern of the transmit power profile is maintained.

In some embodiments, the power control may only be applied during the non-allocated or selected time intervals. Thus, specifically, the transmission during the restricted access time interval may be at the nominal power level whereas the transmit power during the other time intervals may be power controlled to bias it towards the lowest power level that will allow reliable reception at the served UE. Thus, this approach may reduce interference while still ensuring that the common channels are continuously available to the served UE and is furthermore available in the whole cell during the restricted access time interval.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A cellular communication system comprising:
a base station arranged to operate in a restricted mode wherein support is restricted to user equipments of a first associated set of user equipments; the base station further comprising:
a profile unit for determining a first transmit power profile, the first transmit power profile being indicative of the base station operating in the restricted mode; and
a transmitter for transmitting at least one common channel with a transmit power according to the first transmit power profile.

2. The cellular communication system of claim 1 further comprising a user equipment, the user equipment comprising:
a receiver for receiving the at least one common channel from the base station;
an estimating unit for determining a transmit power profile estimate for the at least one common channel;
a decision unit for determining whether to access the base station depending on the transmit power profile estimate.

3. The cellular communication system of claim 2 wherein the estimating unit is arranged to determine the transmit power profile with reference to a transmit power frame for the at least one common channel.

4. The cellular communication system of claim 3 wherein the estimating unit is arranged to determine a timing of the transmit power frame in response to transmissions from the base station.

5. The cellular communication system of claim 2 wherein the user equipment is arranged to store a set of transmit power profile templates for associated sets to which the user equipment belongs; and to access the base station only if the transmit power profile estimate matches a transmit power profile template from the set of transmit power profile templates.

6. The cellular communication system of claim 1 wherein the transmit power profile is indicative of the associated set.

7. The cellular communication system of claim 1 wherein the transmit power profile is one of a set of predefined transmit power profiles.

8. The cellular communication system of claim 1 wherein the transmit power profile comprises a repeated pattern with at least one transmit period having a nominal transmit power and at least one transmit period having a reduced transmit power relative to the nominal power.

9. The cellular communication system of claim 8 wherein the reduced transmit power is at least 20 dB lower than the nominal transmit power.

10. The cellular communication system of claim 8 wherein the repeated pattern comprises only one transmit period at the nominal power, and the transmit power corresponds to the reduced power outside the only one transmit period.

11. The cellular communication system of claim 8 wherein a duration of the at least one transmit period at the nominal transmit power is sufficient for a user equipment to decode the at least one common channel and to transmit an access request to the base station.

12. The cellular communication system of claim 8 wherein a transmit power frame for the at least one common channel is divided into a plurality of time intervals with each time interval being allocated for transmission of the at least one common channel for a subset of possible associated sets, and the repeated pattern corresponds to a transmit power of the nominal transmit power for a time interval for the subset to which the first associated set belongs and to the reduced transmit power for any other time interval.

13. The cellular communication system of claim 1 wherein the base station is arranged to switch from a first transmit mode using the first transmit power profile to a second transmit mode using a second transmit power profile in response to a detection that a number of user equipments supported by the base station exceeds a threshold.

14. The cellular communication system of claim 13 wherein the base station is arranged to switch from the second transmit mode to the first transmit mode in response to a detection that the number of user equipments does not exceed the threshold.

15. The cellular communication system of claim 13 wherein the second transmit power profile has a pattern corresponding to a reduced dynamic range of a pattern of the first transmit power profile.

16. The cellular communication system of claim 13 wherein the second transmit power profile corresponds to a continuous transmission of the broadcast control channel.

17. The cellular communication system of claim 13 wherein the base station is arranged to power control the transmit power for the at least one common channel in response to at least one user equipment supported by the base station when in the second transmit mode.

18. The cellular communication system of claim 1 wherein the control channel comprises data identifying the first associated set.

19. A base station for a cellular communication system, the base station being arranged to operate in a restricted mode wherein support is restricted to user equipments of a first associated set of user equipments; the base station comprising:
a profile unit for determining a first transmit power profile, the first transmit power profile being indicative of the base station operating in the restricted mode; and
a transmitter for transmitting at least one common channel with a transmit power according to the first transmit power profile.

20. A method of operation for a cellular communication system comprising a base station arranged to operate in a restricted mode wherein support is restricted to user equipments of a first associated set of user equipments; the method comprising:
determining a first transmit power profile, the first transmit power profile being indicative of the base station operating in the restricted mode; and
transmitting at least one common channel from the base station with a transmit power according to the first transmit power profile.
